(19) United States
(12) Patent Application Publication
(10) Pub. No.: US 2001/0045728 A1
(43) Pub. Date: Nov. 29, 2001

(54) DASHBOARD

(76) Inventors: UDO KANSTEINER, WITTEN (DE); MARKUS KERKHOFF, WUPPERTAL (DE)

Correspondence Address: KATHRYN A MARRA, DELPHI TECHNOLOGIES INC, LEGAL STAFF, P O BOX 5052 MAIL CODE 480 414 420, TROY, MI, 480075052

(21) Appl. No.: 09/376,277

(22) Filed: Aug. 18, 1999

(30) Foreign Application Priority Data
Aug. 18, 1998 (DE) 19837421.6

(51) Int. Cl. B60R 21/20

(52) U.S. Cl. 280/728.3; 280/732

(57) ABSTRACT

The invention relates to a dashboard for motor vehicles comprising a base part having a region which can be removed by an inflating airbag and which forms a part of the surface of the base part which points to the passenger space in the installed state, with the base part being manufactured of a plastic of low density, preferably of a foamed plastic, in particular of expanded polypropylene (EPP).

### TECHNICAL FIELD

The invention relates to a dashboard for motor vehicles.

### BACKGROUND OF THE INVENTION

In the manufacture of dashboards of this kind, points of view of both design and function are to be taken into account; and safety regulations which are in effect are to be observed as well.

The problem (object) lying at the basis of the invention is to provide a dashboard which can be used in vehicles which are equipped with airbags and can be manufactured simply and with any desired shaping, which has as low a weight as possible, which satisfies all safety regulations and which is capable of being recycled to the greatest possible extent.

### SUMMARY OF THE INVENTION

The solution of this problem takes place through the features of claim 1 and in particular in that a base part is provided which has a region which is removable by an inflating airbag and which forms a part of the surface of the base part which points to the passenger space in the installed state, with the base part being manufactured of a plastic of low density, preferably of a foamed plastic, in particular of expanded polypropylene (EPP).

Through the use of a plastic of low density for the base part the total weight of the dashboard can be kept low.

Moreover, the provision of the removable region at the base part enables the dashboard in accordance with the invention to be used in motor vehicles which are equipped with airbags. Through the integration of the outlet for the inflating airbag into the base part in the form of a removable region the entire dashboard can be manufactured economically in only one work step. Furthermore, through the use of only a single material for the dashboard its recycling capability is improved.

In accordance with a preferred exemplary embodiment of the invention expanded polypropylene (EPP) is used as the material for the base part.

Through the use of this material the manufacturing costs for the dashboard can be kept low and the stability criteria required in respect to the safety regulations in effect can nevertheless be observed. Moreover, with EPP as a material for the dashboard, the latter can be manufactured in any form desired so that all present and future design requirements can be fulfilled with the invention.

In accordance with a further preferred embodiment of the invention the surface of the base part which points to the passenger space in the installed state is provided with a cover in the form of a plastic foil manufactured of a thermoplastic polyolefine (TPO), or made of a modified multiple component material.

The use of a foil of this kind enables the surface of the base part which points to the passenger space to be provided with the respective desired surface properties. Since in accordance with this embodiment a combination of materials from one material family takes place, the advantageous properties of the EPP which is used for the base part and in particular the recycling capability of the entire dashboard are not impaired.

In accordance with a further preferred embodiment of the invention weakenings of the base part in the form of incisions and/or depressions are provided at the rear side of the base part, which are invisible from the passenger space in the installed state. Through this the dashboard in accordance with the invention can also be used in vehicles without an airbag without giving the false impression by airbag cover contours which are visible from the passenger space that the respective vehicle is equipped with an airbag.

Through the provision of a structure element which is designed as a reinforcement and/or a carrier structure for the base part in accordance with a further preferred exemplary embodiment of the invention, with the base part and the structure element preferably being firmly connected to one another, in particular being welded, the stability of the dashboard in accordance with the invention is increased and a simple installation of the dashboard in the vehicle is enabled.

### BRIEF DESCRIPTION OF THE DRAWINGS

The present invention will now be described, by way of example, with reference to the accompanying drawings, in which:

FIG. 1 is a part of a dashboard designed in accordance with the invention in a sectioned side view.

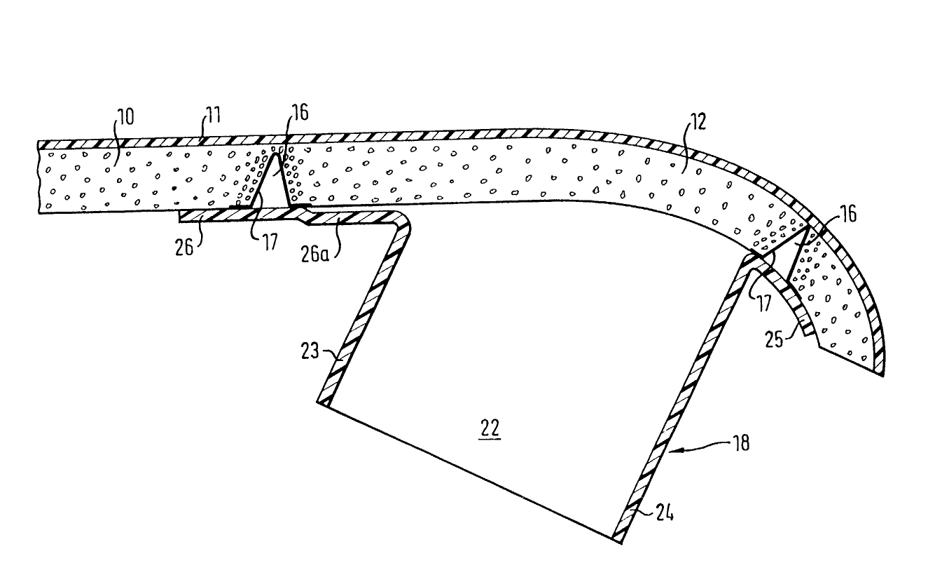

### DESCRIPTION OF THE PREFERRED EMBODIMENT

In the embodiment in accordance with the figure the dashboard in accordance with the invention comprises a base part 10 which is manufactured of expanded polypropylene (EPP), with it being possible in principle for another plastic of low density, e.g. a foamed plastic, to be used.

The surface of the base part 10 which points to the passenger space—in the figure upwardly and to the right—in the installed state is covered with a plastic foil 11 which is manufactured of a thermoplastic polyolefine (TPO), but can in principle consist of another material, e.g. of a modified multiple component material.

The base part 10 has a removable region 12, the outline of which is determined by material weakenings which are provided in the form of V-shaped depressions 16 on the rear side of the base part 10 and which are not visible from the passenger space in the installed state. These depressions 16 can for example be produced through the pressing in of a corresponding tool into the not yet completely hardened plastic material of the base part 10, through which the base part 10 has a higher density in the region of the side walls which extend at an inclination and bound the depressions 16 than does the bordering material.

Furthermore, the base part 10 has skin coverings 17 at side walls which extend at an inclination and bound the depressions 16 and at regions of its rear side which border on the depressions 16.

The depression 16 which in the installed state is nearer to the windshield of the motor vehicle and is on the left in the figure is of lesser depth than the other depressions 16, which extend up to the TPO foil 11. The distance between the lowest position of the left depression 16 and the TPO foil 11 amounts to for example 1.5 mm.

The base part 10 is supported by a box-shaped structure element 18 which serves as a carrier structure and of which the side wall sections 23, 24 and support sections 25, 26 can be recognised in the figure.

The base part 10 is firmly connected to the structure element 18 at the sections 25, 26 which extend parallel to the base part 10 by vibration welding, with it being possible in principle for the connection to take place in a different way. The structure element 18 is manufactured of a material which is different from that of the base part 10.

In its region which faces the windshield of the motor vehicle in the installed state the base part 10 can be supported by a further, non-illustrated structure element.

The removable region 12 of the base part 10 is designed as an airbag cover which contacts the structure element 18 only in the region of the skin coverings 17 and is spaced from a receding region 26a of the section 26 of the structure element 18.

The sections 23, 24 of the structure element 18 which point away from the base part 10 form a shot channel 22 for an inflating airbag which in the installed state is arranged in a non-illustrated airbag module beneath the removable region 12 of the base part 10, which serves as an airbag cover.

When in the event of a collision the airbag is inflated, spreads out through the shot channel 22 and presses against the removable region 12, the base part 10 is broken open at those weakenings which are designed as depressions 16 which extend up to the TPO foil 11 and thus as desired breaking locations. The removable region 12 can then open and is pivoted around in the direction of the windshield of the vehicle as a result of its connection to the base part 10 in the region of the left depression 16 in the figure.

The weakening 16 of the base part 10 facing the windshield of the vehicle, i.e. the material of the base part 10 and the TPO foil 11 in the region of the left depression 16 in the figure, thus act as a hinge region at which the removable region 12 is anchored so that the removable region 12 can not be flung through the interior of the vehicle.

Alternatively, a separate airbag cover can also be provided which is firmly connected at the rear side of the base part 10 to the removable region 12 and is formed in a single piece with the structure element 18. For example an airbag cover of this kind can be connected to the section 23 of the structure element 18 which faces away from the base part 10 via a hinge region of reduced material strength.

It is also possible to provide an airbag cover as a separate component and to anchor it at the structure element 18 by means for example of a retention band which is manufactured of nylon.

1. Dashboard for motor vehicles comprising a base part (10) having a region (12) which can be removed by an inflating airbag and which forms a part of the surface of the base part (10) which points to the passenger space in the installed state, with the base part (10) being manufactured of a plastic of low density, preferably of a foamed plastic, in particular of expanded polypropylene (EPP).

2. Dashboard in accordance with claim 1, characterised in that the removable region (12) of the base part (10) is designed as an airbag cover which can be anchored at the vehicle and which can be impacted by an inflating airbag.

3. Dashboard in accordance with at least one of the preceding claims, characterised in that the removable region (12) of the base part (10) is determined through weakenings (16) of the base part (10) having in particular a lower strength or thickness than surrounding material.

4. Dashboard in accordance with at least one of the preceding claims, characterised in that weakenings (16) of the base part (10) are provided in the form of incisions and/or preferably groove-like, in particular V-shaped depressions.

5. Dashboard in accordance with at least one of the preceding claims, characterised in that incisions or depressions respectively are provided at the rear side of the base part (10) and are invisible from the passenger space in the installed state.

6. Dashboard in accordance with at least one of the preceding claims, characterised in that the base part (10) has skin coverings (17) at the rear side of the base part (10) at least in the region of incisions or depressions respectively.

7. Dashboard in accordance with at least one of the preceding claims, charactrised in that at least one weakening (16) of the base part (10) is formed as a hinge region, with this weakening preferably being formed as an incision or a V-shaped depression (16), of which the depth is less than that of incisions or depressions (16) respectively which in each case serve as a desired breaking location.

8. Dashboard in accordance with at least one of the preceding claims, characterised in that the surface of the base part (10) which points to the passenger space in the installed state is provided with a cover (11) preferably in the form of a plastic foil which is manufactured in particular of a thermoplastic polyolefine (TPO), or made of a modified multiple component material.

9. Dashboard in accordance with at least one of the preceding claims, characterised in that a structure element (18) is designed as a reinforcement and/or carrier structure for the base part (10), with the base part (10) and the structure element (18) preferably being firmly connected, in particular welded, to one another.

10. Dashboard in accordance with at least one of the preceding claims, characterised in that a structure element (18) is designed at least region-wise as a shot channel (22) for an inflating airbag.

11. Dashboard in accordance with at least one of the preceding claims, characterised in that an airbag cover which can be anchored to the vehicle and which can be impacted by an inflating airbag, is firmly connected at the rear side of the base part (10) to the removable region (12).

12. Dashboard in accordance with at least one of the preceding claims, characterised in that an airbag cover is anchored, in particular is pivotally connected, at least at one structure element (18) which can be firmly connected to the vehicle body and which is preferably manufactured of the same material as the airbag cover.

13. Dashboard in accordance with at least one of the preceding claims, characterised in that an airbag cover is designed in a single piece with a structure element (18), with at least one hinge region of reduced material strength or thickness preferably being provided between the airbag cover and the structure element (18).

14. Dashboard in accordance with at least one of the preceding claims, characterised in that the airbag cover is connected to the structure element (18) via a retention band which is preferably manufactured of nylon.
